(19) United States
(12) Patent Application Publication
(10) Pub. No.: US 2011/0012711 A1
(43) Pub. Date: Jan. 20, 2011

(54) Information processing apparatus, information processing method and program

(75) Inventor: Hiroshi Abe, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/802,948

(22) Filed: Jun. 17, 2010

(30) Foreign Application Priority Data
Jul. 14, 2009 (JP) P2009-165403

(51) Int. Cl. G06F 7/04

(52) U.S. Cl. 340/5.82

(57) ABSTRACT

There is provided an information processing apparatus according to the present invention including an authentication processing unit for authenticating biometrics information unique to a living body and an application control unit for controlling an application providing a predetermined service according to the authentication result of the biometrics information and requesting the authentication processing unit to authenticate the biometrics information. The authentication processing unit includes a biometrics information authentication unit for authenticating the biometrics information based on registered biometrics information that is biometrics information registered in advance and an attribute certificate generation unit for generating an attribute certificate indicating information about a valid period of the authentication result of the biometrics information when the biometrics information authentication unit has successfully authenticated the biometrics information. When the attribute certificate is issued for the biometrics information whose authentication is requested, the issued attribute certificate is stored.

### BACKGROUND OF THE INVENTION

1. Field of the Invention

The present invention relates to an information processing apparatus, an information processing method, and a program.

2. Description of the Related Art

With the progress in information processing technology and information communication technology, multiple devices are often connected to each other, so as to share and exchange data and perform cooperated work over remote locations. The combination of the devices connected to each other is not fixed. In many cases, the combination is made up of many devices. Therefore, authentication procedure for authenticating the user is widely employed to prevent illegal use and leak of information caused by so-called “spoofing”.

As an example of such authentication procedure, authentication procedure using a pin number or password has been used in the past. In addition to such authentication procedure, for example, Japanese Patent Application Laid-Open No. 2007-249594 suggests biometrics authentication which can ensure security more easily.

Herein, the authentication method using the apparatus described in Japanese Patent Application Laid-Open No. 2007-249594 needs to have the step of generating biometrics information every time individual authentication is requested of the apparatus carrying out individual authentication (which may also be referred to as “authentication device”), in order to prevent spoofing. Accordingly, every time the user uses the authentication device, the authentication device generates biometrics information from a portion of a living body held over the apparatus. As a result, there is a problem in that individual authentication may not be performed in a short time, even though it is necessary to perform a series of processings required in the individual authentication in a short time.

In light of the foregoing, it is desirable to provide an information processing apparatus, an information processing method, and a program which do not need to generate biometrics information from a portion of a living body on every individual authentication.

According to an embodiment of the present invention, there is provided an information processing apparatus including an authentication processing unit that authenticates biometrics information unique to a living body, and an application control unit that controls an application providing a predetermined service according to the authentication result of the biometrics information, and that requests the authentication processing unit to authenticate the biometrics information. The authentication processing unit includes a biometrics information authentication unit that authenticates the biometrics information based on registered biometrics information that is biometrics information registered in advance, and an attribute certificate generation unit that generates an attribute certificate indicating information about a valid period of the authentication result of the biometrics information, when the biometrics information authentication unit successfully authenticates the biometrics information, and when the attribute certificate is issued for the biometrics information whose authentication is requested, the application control unit stores the issued attribute certificate.

When the application control unit has the attribute certificate, the application control unit may request the authentication processing unit to verify the attribute certificate instead of authenticating the biometrics information, the authentication processing unit further may include a certificate verification unit that verifies the attribute certificate transmitted from the application control unit and outputs the verification result of the attribute certificate to the application control unit, and when a time at which the verification is performed is determined to be within the valid period indicated in the attribute certificate, the certificate verification unit may determine that the attribute certificate has been successfully verified.

The application control unit may notify the authentication processing unit of information about the valid period of the authentication result when the biometrics information is successfully authenticated, and the attribute certificate generation unit may determine the valid period of the attribute certificate based on the information about the valid period notified by the application control unit.

When the time at which the verification is performed is determined not to be within the valid period, the certificate verification unit may notify the application control unit that the attribute certificate is out of the valid period, and when the application control unit obtains the notification, the application control unit may request the authentication processing unit to authenticate the biometrics information.

The authentication processing unit may further include a storage unit that stores a key pair unique to the authentication processing unit, the key pair including a public key and a secret key, and a signature attaching unit that uses the key pair to attach a digital signature to the attribute certificate generated by the attribute certificate generation unit, and the certificate verification unit may use the key pair to verify the digital signature attached to the attribute certificate before verifying the valid period.

According to an embodiment of the present invention, there is provided an information processing method. An information processing apparatus includes an authentication processing unit and an application control unit. The authentication processing unit includes a biometrics information authentication unit and an attribute certificate generation unit. The biometrics information authentication unit authenticates biometrics information unique to a living body based on registered biometrics information that is biometrics information registered in advance. The attribute certificate generation unit generates an attribute certificate indicating information about a valid period of the authentication result of the biometrics information when the biometrics information authentication unit successfully authenticates the biometrics information. The application control unit controls an application providing a predetermined service according to the authentication result of the biometrics information and requests the authentication processing unit to authenticate the biometrics information. The information processing method including the steps of causing the application control unit to request the biometrics information authentication unit to authenticate the biometrics information, causing the biometrics information authentication unit to authenticate the biometrics information, causing the attribute certificate generation unit to generate an attribute certificate indicating information about the valid period of the authentication result of the biometrics information, when the biometrics information has been successfully authenticated, and causing the application control unit to store the attribute certificate generated for the biometrics information whose authentication is requested.

According to an embodiment of the present invention, there is provided a program for causing a computer to achieve a biometrics information authentication function for authenticating biometrics information unique to a living body based on registered biometrics information that is biometrics information registered in advance, an attribute certificate generation function for generating an attribute certificate indicating information about a valid period of an authentication result of the biometrics information when the biometrics information has been successfully authenticated, and an application control function for controlling an application providing a predetermined service according to the authentication result of the biometrics information and requesting the biometrics information authentication function to authenticate the biometrics information. The application control function stores the attribute certificate when the attribute certificate is generated for the biometrics information whose authentication is requested.

### SUMMARY OF THE INVENTION

As described above, when the biometrics information is successfully authenticated, the information processing apparatus according to an embodiment of the present invention generates an attribute certificate indicating the valid period of the authentication result of this biometrics information. The information processing apparatus uses the attribute certificate, and accordingly the information processing apparatus can provide a predetermined service without generating biometrics information from a portion of a living body on every individual authentication.

### BRIEF DESCRIPTION OF THE DRAWINGS

FIG. 1 is a block diagram illustrating a configuration of an information processing apparatus according to a first embodiment of the present invention;

FIG. 2 is an explanatory diagram illustrating an attribute certificate;

FIG. 3 is an explanatory diagram illustrating the information processing apparatus according to the embodiment;

FIG. 4 is an explanatory diagram illustrating the information processing apparatus according to the embodiment;

FIG. 5A is an explanatory diagram illustrating an authentication processing unit according to the embodiment;

FIG. 5B is an explanatory diagram illustrating an authentication processing unit according to the embodiment;

FIG. 6A is an explanatory diagram illustrating a modification of the information processing apparatus according to the embodiment;

FIG. 6B is an explanatory diagram illustrating a modification of the information processing apparatus according to the embodiment;

FIG. 7 is a flow diagram illustrating an information processing method according to the embodiment; and

FIG. 8 is a block diagram illustrating a hardware configuration of the information processing apparatus according to the embodiment of the present invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The explanation will be made in the following order.

(1) First embodiment

(1-1) Configuration of information processing apparatus

(1-2) Modification of information processing apparatus

(1-3) Information processing method

(2) Hardware configuration of information processing apparatus according to an embodiment of present invention

(3) Summary

### First Embodiment

### <Configuration of Information Processing Apparatus>

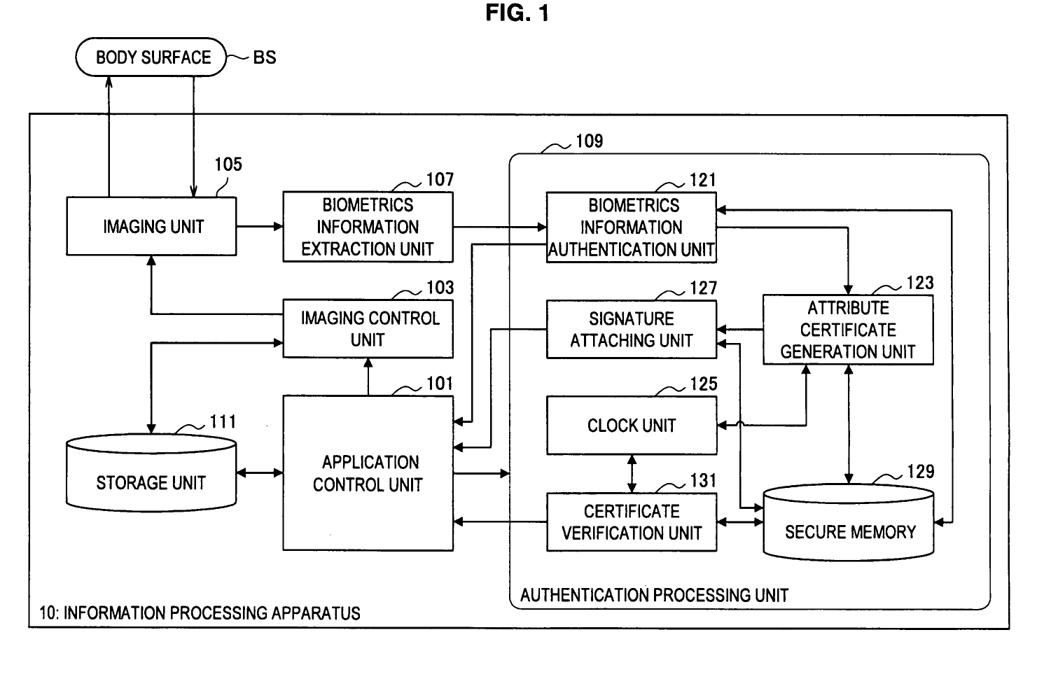

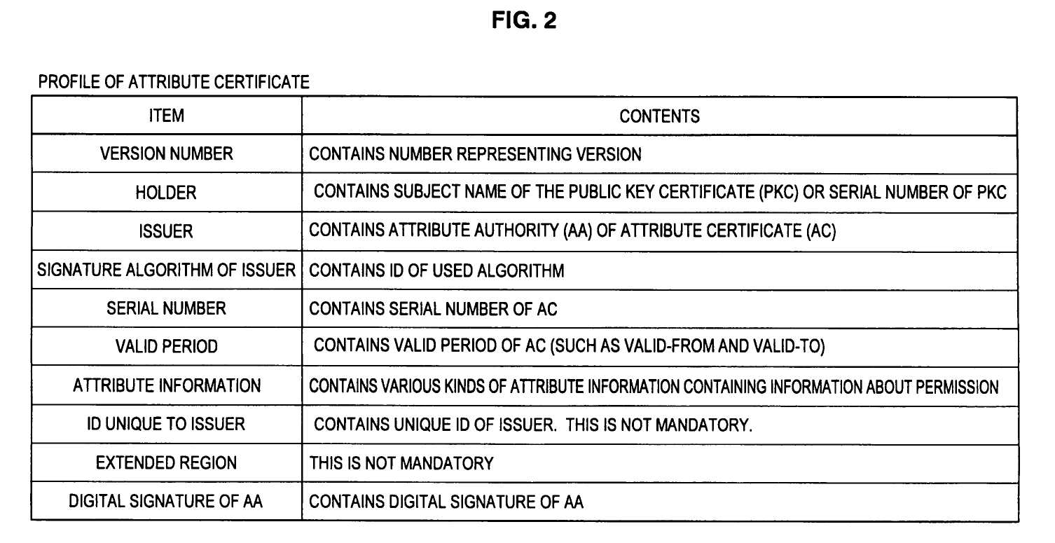

First, a configuration of an information processing apparatus according to the first embodiment of the present invention will be described in detail with reference to FIG. 1 and FIG. 2. FIG. 1 is a block diagram illustrating a configuration of the information processing apparatus according to the present embodiment. FIG. 2 is an explanatory diagram illustrating an attribute certificate.

In the following explanation, for example, a vein authentication will be described as an example of biometrics authentication. At this occasion, vein information about a pattern present in a vein of a living body is used as biometrics information unique to a living body. However, the present invention is not limited to only the vein authentication, but may also be applied to various other kinds of biometrics authentication such as fingerprint authentication, face authentication, and iris authentication.

For example, as shown in FIG. 1, the information processing apparatus 10 according to the present embodiment mainly includes an application control unit 101, an imaging control unit 103, an imaging unit 105, a biometrics information extraction unit 107, an authentication processing unit 109, and a storage unit 111.

The application control unit 101 is achieved with a CPU (Central Processing Unit), ROM (Read Only Memory), a RAM (Random Access Memory), and the like. The application control unit 101 controls an application, which provides a predetermined service to the user of the information processing apparatus 10, according to authentication result of biometrics information unique to a living body, and requests the later-described authentication processing unit 109 to authenticate the biometrics information.

The application whose execution is controlled by the application control unit 101 is an application which authenticates the user when a service obtained by executing the application is provided to the user. Examples of such application include an application managing login to the information processing apparatus 10 itself and an application allowing the user to view private information such as a mailer. In addition to the applications listed above, examples can further include various kinds of applications such as an application managing the use of electronic money and an application managing an automatic ticket gate system.

In order to authenticate the user of the information processing apparatus 10, the application control unit 101 requests the later-described imaging control unit 103 to image the surface of the body of the user, and requests the later-described authentication processing unit 109 to authenticate biometrics information extracted from the imaging result. In addition, the application control unit 101 determines whether the service obtained by executing the application is to be provided, according to the authentication result of the biometrics information transmitted from the authentication processing unit 109. In other words, when the authentication processing unit 109 transmits authentication result information indicating that biometrics information has been successfully authenticated, the application control unit 101 provides the user of the information processing apparatus with the service obtained by executing the application. When the authentication processing unit 109 transmits authentication result information indicating that authentication of biometrics information has failed, the application control unit 109 stops the execution of the application.

When the application control unit 101 requests the authentication processing unit 109 to authenticate biometrics information, the application control unit 101 also transmits information about an valid period of an authentication result indicating that the biometrics information has been successfully authenticated (hereinafter referred to as “valid period information”) to the authentication processing unit 109. For example, this valid period information is, for example, information indicating that “the authentication result about the success of the authentication is effective for ten minutes since the success of the authentication”. The application control unit 101 sets this valid period information according to the content of the service provided by the application control unit 101, and accordingly, the application control unit 101 can manage the valid period of the attribute certificate which will be described later. When the setting of multiple security levels are required for each content of service provided to the user, the application control unit 101 may set different valid period information for each security level.

In addition, when the authentication processing unit 109 transmits not only the authentication result information indicating the success of the authentication but also a later-described attribute certificate, the application control unit 101 stores this attribute certificate to the inside of the application control unit 101, the later-described storage unit 111, and the like. At this occasion, the application control unit 101 may store, in association with the attribute certificate, user identification information (for example, identification number) corresponding to the authentication result information indicating the success of the authentication to the storage unit 111 and the like. By associating such identification information with the attribute information, the corresponding relationship between the user and the stored attribute certificate can be easily understood.

There may be a case where an attribute certificate (AC) about the user may be stored when the user requests the application to be provided. In such case, the application control unit 101 does not request the authentication processing unit 109 to authenticate biometrics information. Instead, the application control unit 101 transmits the stored attribute certificate to the authentication processing unit 109 and requests the authentication processing unit 109 to verify the attribute certificate.

At this occasion, when the authentication processing unit 109 transmits a message indicating that the attribute certificate has been successfully verified, the application control unit 101 deems that the biometrics information has been successfully authenticated, and provides a predetermined service to the user corresponding to the attribute certificate. Accordingly, while the attribute certificate is successfully verified, it is not necessary to perform the processing of imaging the surface of the body, extracting biometrics information, and authenticating the extracted biometrics information, and therefore, it is possible to greatly reduce the time for providing the service. As a result, the convenience of the user of the information processing apparatus 10 can be improved.

On the other hand, when the authentication processing unit 109 transmits a message indicating that the verification of the attribute certificate has failed, the application control unit 101 may request the imaging control unit 103 to image the surface of the body of the user, and may request the authentication processing unit 109 to perform authentication processing using newly extracted biometrics information. Even when the verification of the attribute certificate has failed, the ordinary authentication processing using the biometrics information can be performed, and therefore, the service can be provided without sacrificing the convenience of the user.

It should be noted that the application control unit 101 may have a key pair including a public key and a secret key, unique to the application control unit 101, which are generated according to a predetermined method, and the application control unit 101 may have a public key certificate for this key pair. The public key certificate in the application control unit 101 enables secure mutual authentication processing with the authentication processing unit 109, and also enables more secure transmission of the biometrics information and the attribute certificate to the authentication processing unit 109.

Herein, a Public Key Certificate (PKC) is generated using a Public Key Infrastructure (PKI). The public key certificate includes a user identification (ID) such as the name of the user, a MAC address, or an e-mail address and a public key corresponding to this user ID, which are signed with a digital signature. The digital signature is generated by deriving a fixed-length data such as a hash value from the user ID and the public key using a one-way-function and encrypting the derived fixed-length data using a signature secret key.

Although FIG. 1 shows only one application control unit 101, a plurality of application control units 101 may be arranged within the information processing apparatus 10 according to the number of services provided by the information processing apparatus 10. Alternatively, one application control unit 101 may control multiple kinds of applications, which are different from each other, so as to provide multiple kinds of services.

The imaging control unit 103 is achieved with, for example, a CPU, a ROM, a RAM, and the like. The imaging control unit 103 controls a light source unit, an optical system, and an imaging element of the imaging unit 101, which are described later, so as to generate imaged data representing the body surface BS.

The imaging control unit 103 outputs the imaged data generated by the imaging element to the later-described biometrics information extraction unit 107. Further, the imaging control unit 103 may store the obtained imaged data to the storage unit 111. When the imaged data is recorded to the storage unit 111, the imaging control unit 103 may associate the generated imaged data with a date of imaging, a time of imaging, and the like. It should be noted that the generated imaged data may be an RGB (Red-Green-Blue) signal, or may be image data of other colors or in grayscale.

The imaging unit 105 includes a light source unit emitting near-infrared light having a predetermined wavelength band onto a body surface BS and an optical system including optical elements such as the imaging element and lenses.

Because the near-infrared light has characteristics that it is well transmitted through body tissues and absorbed by hemoglobin (reduced hemoglobin) in blood, if the near-infrared light is emitted on the finger, palm or back of a hand, veins distributed inside the finger, palm or back of the hand appear as a shadow in an image. The shadow of veins that appears in an image is called a vein pattern. In order to suitably image such a vein pattern, the light source unit of the light emitting diode, and the like, emits near-infrared light having a wavelength of about 600 nm to 1300 nm or, preferably, about 700 nm to 900 nm.

If the wavelength of the near-infrared light emitted by the light source is less than 600 nm or more than 1300 nm, the percentage of light that is absorbed by hemoglobin in blood decreases, and it becomes difficult to obtain a suitable vein pattern. Also, if the wavelength of the near-infrared light emitted by the light source is about 700 nm to 900 nm, the near-infrared light is specifically absorbed by both deoxygenated hemoglobin and oxygenated hemoglobin, and it is therefore possible to obtain a suitable vein pattern.

The near infrared light exit from the light source is propagated towards the body surface BS, and enters inside from the side surface and the like of the living body as a direct light. Since a human body is a suitable scatterer of near infrared light, the direct light that entered inside the living body propagates while scattering in all directions. The near infrared light that passed through the living body enters the optical element configuring the optical system.

The optical system configuring the imaging unit 105 is configured by one or a plurality of optical elements, and one or a plurality of imaging elements.

Human skin is known to have a three-layer structure including an epidermis layer, a dermis layer and a subcutaneous tissue layer, where the vein layer in which the vein exists is in the dermis layer. The dermis layer is located at about 0.1 mm to 0.3 mm below the finger surface and has a thickness of about 2 mm to 3 mm. Thus, by setting the focal position of the optical element such as the lens at the position where the dermis layer exists (e.g. at the position that is about 1.5 mm to 2.0 mm below the finger surface), it becomes possible to efficiently condense the light transmitted through the vein layer.

The transmitted light having passed through the vein layer is condensed by an optical element to form an image on an imaging element such as a CCD and a CMOS to be made into vein imaged data. The vein imaged data corresponding to the generated vein imaged image is transmitted to the later-described biometrics information extraction unit 107.

The biometrics information extraction unit 107 is achieved with, for example, a CPU, a ROM, a RAM, and the like. The biometrics information extraction unit 107 extracts vein image representing the user's vein pattern from among imaged data transmitted from the imaging unit 105. This vein image is biometrics information serving as information unique to a living body. This biometrics information extraction unit 107 further includes processing units such as an image smoothing unit, an outline extraction unit, a mask image generation unit, a cropping unit, a vein smoothing unit, a binary conversion unit, a thick line conversion unit, a thin line conversion unit, a thumbnail image generation unit, and the like.

The image smoothing unit is achieved with, for example, a CPU, a ROM, a RAM, and the like. The image smoothing unit uses, for example, a so-called Gaussian spatial filter to filter the vein imaged data given as an imaging result, thus smoothing the vein image corresponding to the vein imaged data.

The outline extraction unit is achieved with, for example, a CPU, a ROM, a RAM, and the like. The outline extraction unit uses, for example, a so-called Log (Laplacian of Gaussian) spatial filter to filter the vein image smoothed by the image smoothing unit, thus emphasizing the outline of the vein image to produce an engraved image.

The mask image generation unit is achieved with, for example, a CPU, a ROM, a RAM, and the like. The mask image generation unit detects an outline such as an outline of a finger, based on a contrast with respect to a background section, from the vein image whose outline has been emphasized by the outline extraction unit. The mask image generation unit generates an image (which may also be referred to as a mask image) that represents, using binary values, a finger region enclosed by the detected outline and a region other than the finger region.

The cropping unit is achieved with, for example, a CPU, a ROM, a RAM, and the like. The cropping unit uses the mask image generated by the mask image generation unit to crop out an image of a predetermined size including the finger region enclosed by the outline of the finger from the vein image whose outline has been emphasized by the outline extraction unit.

The vein smoothing unit is achieved with, for example, a CPU, a ROM, a RAM, and the like. The vein smoothing unit uses, for example, a so-called median spatial filter to filter the vein image cropped out by the cropping unit, thus smoothing the vein section in the vein image.

The binary conversion unit is achieved with, for example, a CPU, a ROM, a RAM, and the like. The binary conversion unit converts the vein image in which the vein section is smoothed by the vein smoothing unit into binary levels, using the configured brightness level as the reference. Now, if the vein image in which the vein has not yet been smoothed is adopted as the image to be subjected to the binary conversion, it is more likely that one vein may be separated into two veins as a result of binary conversion process even though there is only one vein in reality. On the other hand, when the vein image in which the vein is smoothed is adopted as the image to be subjected to the binary conversion process, the binary conversion process can be carried out in a state approximating to the actual vein.

The thick line conversion unit is achieved with, for example, a CPU, a ROM, a RAM, and the like. The thick line conversion unit uses, for example, a so-called dilation spatial filter to filter the vein image converted into binary values by the binary conversion unit, thus making the vein in the vein image into a thicker line. As a result, this filter connects disconnected vein sections which should be connected in reality.

The thin line conversion unit is achieved with, for example, a CPU, a ROM, a RAM, and the like. The thin line conversion unit uses, for example, a so-called erosion spatial filter to filter the vein image in which the vein section is converted into a thick line by the thick line conversion unit, thus making the width of the vein in the vein section constant.

The thumbnail image generation unit is achieved with, for example, a CPU, a ROM, a RAM, and the like. The thumbnail image generation unit obtains from the thin line conversion unit the vein image that represents, using binary values, the vein section in which the width of the vein is constant and the background section, and generates a thumbnail image from this vein image by compressing the vertical and horizontal sizes by one n-th.

In this way, the biometrics information extraction unit 107 extracts, as biometrics information about the vein, the image representing, using binary values, the vein section in which the width of the vein is constant and the background section. The biometrics information extraction unit 107 transmits the extracted vein image (i.e., the vein image in which the vein section is converted into a thin line) to the later-described authentication processing unit 109. It should be noted that the biometrics information extraction unit 107 may record, to the storage unit 111, the extracted vein image, the thumbnail image, and various kinds of information generated by each processing unit of the biometrics information extraction unit 107.

The authentication processing unit 109 is achieved with, for example, a CPU, a ROM, a RAM, and the like. When the application control unit 101 requests authentication of biometrics information, the authentication processing unit 109 authenticates biometrics information corresponding to the authentication request transmitted from the biometrics information extraction unit 107. On the other hand, when the application control unit 101 requests verification of a later-described attribute certificate, the authentication processing unit 109 verifies the attribute certificate transmitted from the application control unit 101.

When the application control unit 101 has a public key certificate (PKC) unique to the application control unit 101, the authentication processing unit 109 may perform mutual authentication processing with the application control unit 101. This mutual authentication processing is performed according to a predetermined method using public key certificates respectively possessed by the application control unit 101 and the authentication processing unit 109.

Other functions of the authentication processing unit 109 will be hereinafter described in detail.

The storage unit 111 may store various parameters or progress of processing that are necessary to be stored while the information processing apparatus 10 according to the present embodiment performs certain processing, and may store various kinds of databases and the like as necessary. The storage unit 111 can be freely read and written by the application control unit 101, the imaging control unit 103, the imaging unit 105, the biometrics information extraction unit 107, and the like.

It should be noted that the user of the information processing apparatus 10 according to the present embodiment can use the apparatuses having the same functions as the imaging control unit 103, the imaging unit 105, and the biometrics information extraction unit 107 of the information processing apparatus 10 according to the present embodiment to register biometrics information, thumbnail images, information about various kinds of feature quantities, and the like in advance.

### (Configuration of Authentication Processing Unit]

Subsequently, the authentication processing unit 109 according to the present embodiment will be described in detail.

For example, as shown in FIG. 1, the authentication processing unit 109 according to the present embodiment mainly includes a biometrics information authentication unit 121, an attribute certificate generation unit 123, a clock unit 125, a signature attaching unit 127, a secure memory 129, and a certificate verification unit 131.

The biometrics information authentication unit 121 is achieved with, for example, a CPU, a ROM, a RAM, and the like. The biometrics information authentication unit 121 authenticates biometrics information based on registered biometrics information, i.e., biometrics information registered in advance. More specifically, the biometrics information authentication unit 121 compares the biometrics information transmitted from the biometrics information extraction unit 107 with the registered biometrics information, so as to determine whether the biometrics information is similar to the registered biometrics information or not. Herein, the biometrics information authentication unit 121 can obtain the registered biometrics information used for the authentication processing (which may be hereinafter referred to as “template”) from the later-described secure memory 129, an external template management server, and the like.

The comparison between the biometrics information included in the template (for example, the vein information) and the transmitted biometrics information is made by calculating, for example, a correlation coefficient as shown below, and the comparison can be executed based on the calculated correlation coefficient.

The correlation coefficient is defined by the following expression 1, and is a statistical index representing the degree of similarity between two data f1 and f2. The correlation coefficient is a real value from −1 to 1. When the correlation coefficient is a value close to 1, the correlation coefficient indicates that the two data are similar. When the correlation coefficient is a value close to 0, the correlation coefficient indicates that the two data are not similar. When the correlation coefficient is a value close to −1, the correlation coefficient indicates that the two data have opposite signs from each other.

Herein, f1 and f2 are data representing vein information (vein pattern), and each has an image size including M rows and N columns. A pixel in the vein information is represented as (m, n).

$$\begin{matrix}[ Expression 1 ] & \\ S ( f 1 , f 2 ) = \frac{{\sum }_{m = 0}^{M - 1} {\sum }_{n = 0}^{N - 1} f 1 ( m , n ) \cdot f 2 ( m , n )}{\begin{matrix}\sqrt{\{ {\sum }_{m = 0}^{M - 1} {\sum }_{n = 0}^{N - 1} f 1 {( m , n )}^{2} \}} \\ \sqrt{\{ {\sum }_{m = 0}^{M - 1} {\sum }_{n = 0}^{N - 1} f 2 {( m , n )}^{2} \}}\end{matrix}} & ( Expression 1 )\end{matrix}$$

When the determination result based a threshold value of the correlation coefficient indicates that the correlation coefficient is equal to or more than the threshold value and that the biometrics information included in the template is similar to the transmitted biometrics information, the biometrics information authentication unit 121 determines that the transmitted biometrics information has been successfully authenticated. When the correlation coefficient is determined to be less than the predetermined threshold value and the transmitted biometrics information is determined not to be similar to the template, the biometrics information authentication unit 121 determines that the authentication has failed.

The biometrics information authentication unit 121 transmits the authentication result information about the obtained authentication result to the application control unit 101. When the transmitted biometrics information has been successfully authenticated, the biometrics information authentication unit 121 requests the later-described attribute certificate generation unit 123 to generate an attribute certificate.

In the above explanation, the biometrics information authentication unit 121 determines whether the degree of similarity is equal to or more than the predetermined threshold value (in other words, the degree of similarity between the two pieces of information is determined using the correlation). However, the present embodiment is not limited to the above example. Alternatively, the degree of similarity may be determined using a summation of differences. Examples of methods using a summation of differences include Sum of Absolute Difference (SAD) and Sum of Squared Difference (SSD). When the degree of similarity is determined using a summation of differences, the degree of similarity is determined based on whether a calculated summation is equal to or less than a predetermined threshold value.

The attribute certificate generation unit 123 is achieved with, for example, a CPU, a ROM, a RAM, and the like. When the biometrics information authentication unit 121 has successfully authenticated biometrics information, the attribute certificate generation unit 123 generates an attribute certificate (AC) describing information about an valid period of the authentication result of this biometrics information (valid period information). For example, the attribute certificate is a certificate having a profile as shown in FIG. 2. A so-called attribute certificate authority (AA) attaches a digital signature to the attribute certificate. In the authentication processing unit 109 according to the present embodiment, the above attribute certificate authority is the later-described signature attaching unit 127.

The attribute certificate can describe various kinds of information as shown in FIG. 2. The attribute certificate generation unit 123 generates the attribute certificate including at least valid period information representing the valid period of the authentication result indicating the success of the authentication and a serial number of a public key certificate associated with the generated attribute certificate. Herein, when the application control unit 101 having requested the authentication of the biometrics information has a public key certificate, the serial number of the public key certificate possessed by the application control unit 101 is written to the attribute certificate. On the other hand, when the application control unit 101 does not have the public key certificate, the serial number of the public key certificate possessed by the authentication processing unit 109 is written to the attribute certificate. Alternatively, even when the application control unit 101 does not have a public key certificate, the serial number of the public key certificate possessed by the authentication processing unit 109 may be written to the attribute certificate.

When the serial number of the public key certificate possessed by the application control unit 101 is written to the attribute certificate, the public key certificate associated with the attribute certificate is verified before the later-described verification of the attribute certificate. Accordingly, the time for the verification slightly increases, but the attribute certificate can be verified in such a manner to ensure safety even when any number of application control units 101 present attribute certificates. On the other hand, when the serial number of the public key certificate possessed by the authentication processing unit 109 is written to the attribute certificate, it is not necessary to verify the public key certificate prior to the verification of the attribute certificate, and accordingly, the time for the later-described verification processing of the attribute certificate can be reduced.

When the attribute certificate generation unit 123 generates an attribute certificate, the attribute certificate generation unit 123 requests the later-described clock unit 125 to provide time information about the current date, time, day of week, and the like. The attribute certificate generation unit 123 writes the time information obtained from the clock unit 125, as a date/time of valid-from of the valid period of the attribute certificate. Further, the attribute certificate generation unit 123 writes a summation of the time information obtained from the clock unit 125 and the valid period written in the valid period information notified by the application control unit 101, as an date/time of valid-to of the valid period of the attribute certificate. The later-described certificate verification unit 131 can investigate the attribute certificate, based on information about the valid period of the attribute certificate that is determined by the date/time of valid-from and the date/time of valid-to of the valid period (hereinafter referred to as “valid period information”).

The attribute certificate generation unit 123 transmits the generated attribute certificate to the later-described signature attaching unit 127. As necessary, the attribute certificate generation unit 123 may temporarily store the generated attribute certificate to the later-described secure memory 129 and the like.

The clock unit 125 is achieved by, for example, a CPU, a ROM, a RAM, and a timer for measuring the current date, time, day of week, and the like. When the attribute certificate generation unit 123 or the later-described certificate verification unit 131 requests the clock unit 125 to provide time information about the current date, time, day of week, and the like, the clock unit 125 provides the time information to the corresponding processing unit.

The signature attaching unit 127 is achieved with, for example, a CPU, a ROM, a RAM, and the like. As described above, the signature attaching unit 127 functions as an attribute certificate authority, and attaches a digital signature to an attribute certificate generated by the attribute certificate generation unit 123. More specifically, the signature attaching unit 127 uses a secret key to attach the digital signature to the attribute certificate transmitted from the attribute certificate generation unit 123. The secret key is unique to the authentication processing unit 109, and is secretly kept by the authentication processing unit 109. As a result, the attached digital signature ensures the integrity of the attribute certificate generated by the attribute certificate generation unit 123. Thereafter, the signature attaching unit 127 transmits the attribute certificate attached with the digital signature to the application control unit 101 having requested the authentication of the biometrics information. In addition, the signature attaching unit 127 may record the attribute certificate attached with the digital signature to the later-described secure memory 129.

The secure memory 129 is an example of a storage unit possessed by the authentication processing unit 109, and the secure memory 129 is a storage unit having tamper resistant property. This secure memory 129 stores a tamper resistant program such as a program for protecting the secure memory 129 from illegal access or a program for deleting data from the secure memory 129 according to illegal access. The information processing apparatus 10 according to the present embodiment manages the secure memory 129 based on this tamper resistant program in a security level higher than that of the storage unit 111.

The secure memory 129 stores the templates used for biometrics authentication processing, the secret key unique to the authentication processing unit 109, and the public key certificate. In addition, the secure memory 129 may store the public key unique to the authentication processing unit 109.

As necessary, the secure memory 129 stores various parameters or progress of processing that are necessary to be stored while the authentication processing unit 109 according to the present embodiment performs certain processing, and may store various kinds of databases and the like as necessary. The secure memory 129 can be freely read and written by each processing unit of the authentication processing unit 109.

The certificate verification unit 131 is achieved with, for example, a CPU, a ROM, a RAM, and the like. The certificate verification unit 131 verifies the attribute certificate transmitted from the application control unit 101, and outputs the verification result of the attribute certificate to the application control unit 101. The verification of the attribute certificate is roughly divided into: a verification processing of the digital signature attached to the attribute certificate; and a verification processing of the valid period information written in the attribute certificate, which is performed after the verification processing of the digital signature. In addition, when the attribute certificate is associated with the public key certificate held in the application control unit 101, the verification processing of the public key certificate associated with the attribute certificate is carried out before the verification processing of the digital signature attached to the attribute certificate. Each of the verification processings will be hereinafter described in detail.

First, the verification processing of the public key certificate will be described. It should be noted that the below-described verification processing of the public key certificate is merely an example. The verification processing of the public key certificate carried out by the certificate verification unit 131 according to the present embodiment is not limited to the following example.

The certificate verification unit 131 uses a public key corresponding to the public key certificate to decrypt the digital signature attached to the public key certificate corresponding to the serial number written in the attribute certificate, and collates the obtained decryption result with a fixed-length data derived from the content of the public key certificate. When the content of the public key certificate does not agree with the fixed-length data, this disagreement therebetween means that the public key certificate is tampered and that the content of the public key certificate is changed, and accordingly, the certificate verification unit 131 determines that the verification has failed. When the content of the public key certificate agrees with the fixed-length data, the certificate verification unit 131 determines that the verification of the public key certificate has succeeded.

By performing the above-described verification processing of the public key certificate, the certificate verification unit 131 has only to verify the attribute certificate transmitted from the application control unit 101 that is determined to be safe. As a result, the certificate verification unit 131 does not have to verify all of the attribute certificates transmitted from any number of application control units 101, and it is possible to prevent a third party from viewing the information stored in the authentication processing unit 109 by illegal means.

It should be noted that the verification processing of the public key certificate is executed when the serial number of the public key certificate unique to the application control unit 101 is written to the attribute certificate. When the serial number corresponding to the public key certificate unique to the authentication processing unit 109 is written to the attribute certificate, the certificate verification unit 131 may omit this verification processing.

Subsequently, the verification processing of the digital signature attached to the attribute certificate will be described. It should be noted that the below-described verification processing of the digital signature attached to the attribute certificate is merely an example. The verification processing of the digital signature carried out by the certificate verification unit 131 according to the present embodiment is not limited to the following example.

The certificate verification unit 131 uses a public key included in a key pair unique to the authentication processing unit 109 to decrypt the digital signature attached to the attribute certificate, and collates the obtained decryption result with a fixed-length data derived from the content of the attribute certificate. When the content of the attribute certificate does not agree with the fixed-length data, this disagreement therebetween means that the attribute certificate is tampered and that the content of the attribute certificate is changed, and accordingly, the certificate verification unit 131 determines that the verification has failed. When the content of the attribute certificate agrees with the fixed-length data, the certificate verification unit 131 determines that the verification of the attribute certificate has succeeded.

By performing the above-described verification processing of the attribute certificate, the certificate verification unit 131 has only to verify the attribute certificate transmitted from the application control unit 101 that is determined to be safe. As a result, the certificate verification unit 131 does not have to verify all of the attribute certificates transmitted from any number of application control units 101, and it is possible to prevent a third party from viewing the information stored in the authentication processing unit 109 by illegal means.

Subsequently, the verification processing of the valid period information will be described. The certificate verification unit 131 references the attribute certificate that has been successfully verified, and obtains the valid period information in the attribute certificate. Further, the certificate verification unit 131 requests the clock unit 125 to provide time information. The certificate verification unit 131 determines whether the time described in the time information obtained from the clock unit 125 (i.e., the time at which the verification processing is performed) is within the valid period described in the valid period information. When the time at which the verification processing is performed is determined to be within the valid period, the certificate verification unit 131 determines that the attribute certificate is effective, and notifies the application control unit 101 that the attribute certificate has been successfully verified. When the time at which the verification processing is performed is determined to be out of the valid period, the certificate verification unit 131 determines that the attribute certificate is invalid, and notifies the application control unit 101 that the verification of the attribute certificate has failed.

By performing the above processing, the certificate verification unit 131 can verify whether the attribute certificate transmitted from the application control unit 101 is effective or not. When the attribute certificate is determined to be effective, the application control unit 101 deems that the biometrics information has been successfully authenticated, and starts providing a predetermined service to a corresponding user. When it is necessary to perform authentication again, for example, right after biometrics information has been successfully authenticated, the user of the information processing apparatus 10 does not require the surface of the body to be held over the information processing apparatus 10 again, and therefore, the convenience of the user can be improved.

### [Flow of Information in Authentication Processing Unit]

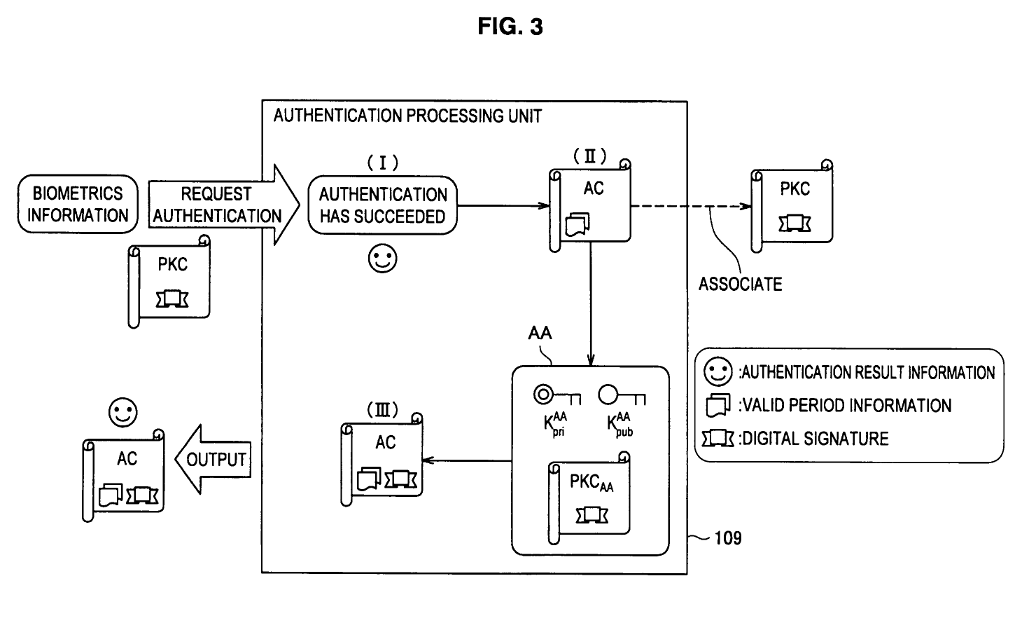

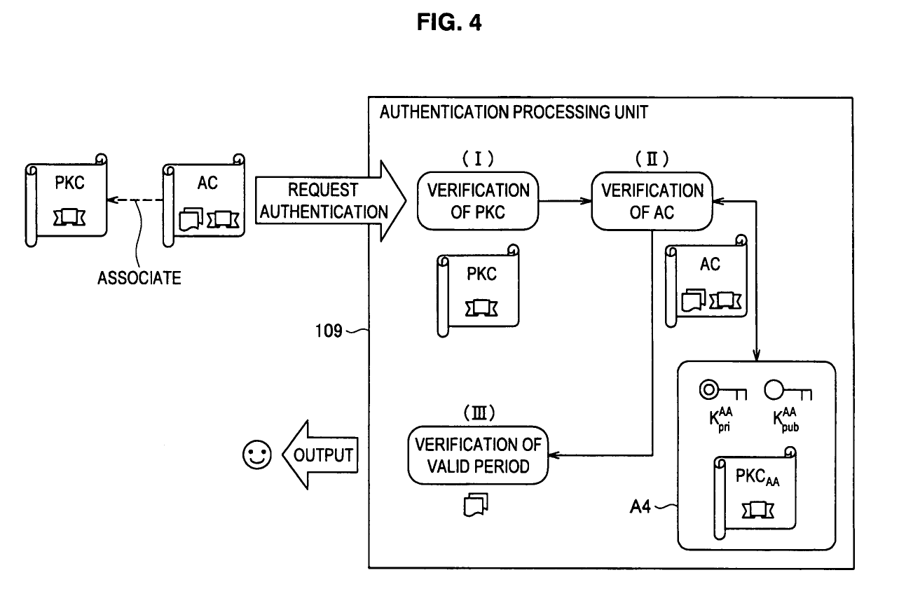

Subsequently, a flow of information in the authentication processing unit 109 will be described in detail with reference to FIG. 3 and FIG. 4. FIG. 3 and FIG. 4 are explanatory diagrams illustrating the flow of information in the authentication processing unit according to the present embodiment.

First, the flow of information will be described with reference to FIG. 3, when the application control unit 101 requests the authentication processing unit 109 to authenticate biometrics information.

When the application control unit 101 requests the authentication processing unit 109 to authenticate biometrics information, the biometrics information extraction unit 107 transmits biometrics information, which is to be authenticated, to the authentication processing unit 109. In addition, the application control unit 101 also notifies the valid period information to the authentication processing unit 109.

When the authentication processing unit 109 receives the authentication request from the application control unit 101, the authentication processing unit 109 may perform mutual authentication using the public key certificate (PKC) possessed by the application control unit 101.

(I) The biometrics information authentication unit 121 in the authentication processing unit 109 authenticates the transmitted biometrics information based on the template registered in advance. When the authentication has succeeded, the biometrics information authentication unit 121 notifies the attribute certificate generation unit 123 of information indicating that the biometrics information has been successfully authenticated, and requests the attribute certificate generation unit 123 to issue an attribute certificate. In addition, the biometrics information authentication unit 121 outputs information about the authentication result (authentication result information) to the application control unit 101.

(II) The attribute certificate generation unit 123 receives from the biometrics information authentication unit 121 the information indicating that the biometrics information has been successfully authenticated, the attribute certificate generation unit 123 generates an attribute certificate (AC) based on the valid period information notified by the application control unit 101. The attribute certificate generation unit 123 adopts the time information obtained from the clock unit 125 as a date/time of valid-from of the valid period of the attribute certificate, and adopts a time/date obtained by adding the time information to the valid period information as a date/time of valid-to of the valid period of the attribute certificate. Further, the attribute certificate generation unit 123 writes a predetermined serial number of the public key certificate to the generated attribute certificate, and associates the public key certificate and the attribute certificate.

(III) The attribute certificate generation unit 123 transmits the generated attribute certificate to the signature attaching unit 127. The signature attaching unit 127 functions as an attribute certificate authority, and uses a secret key unique to the authentication processing unit 109 to attach a digital signature to the transmitted attribute certificate. The attribute certificate generation unit 123 outputs the attribute certificate attached with the digital signature to the application control unit 101.

As a result, the authentication processing unit 109 outputs to the application control unit 101 both of the authentication result information indicating the success of the authentication and the attribute certificate generated according to the success of the authentication.

When the application control unit 101 requests authentication and further requests output of an attribute certificate, or when the authentication processing unit 109 is set with a parameter corresponding to output of an attribute certificate, the output of the attribute certificate may be limited, so that the attribute certificate is not continuously output. However, the authentication processing unit 109 generates an attribute certificate only when the biometrics information authentication unit 121 has succeeded in authentication using biometrics information.

Subsequently, a flow of information will be described with reference to FIG. 4 when the application control unit 101 requests the authentication processing unit 109 to verify an attribute certificate.

When the application control unit 101 stores an attribute certificate output by the authentication processing unit 109, the application control unit 101 requests the authentication processing unit 109 to verify the attribute certificate. In this case, the application control unit 101 transmits the stored attribute certificate to the authentication processing unit 109.

Herein, when the authentication processing unit 109 receives a verification request from the application control unit 101, the authentication processing unit 109 may perform mutual authentication using the public key certificate (PKC) possessed by the application control unit 101.

(I) The certificate verification unit 131 of the authentication processing unit 109 having received the verification request of the attribute certificate determines whether the public key certificate associated with the transmitted attribute certificate is the public key certificate unique to the authentication processing unit 109. When the associated public key certificate is determined not to be the public key certificate unique to the authentication processing unit 109, the certificate verification unit 131 verifies the public key certificate by using the public key corresponding to the public key certificate associated with the attribute certificate.

(II) When the certificate verification unit 131 has successfully verified the public key certificate, the certificate verification unit 131 verifies the attribute certificate requested to be verified. More specifically, the certificate verification unit 131 uses the public key unique to the authentication processing unit 109 to verify the digital signature attached to the attribute certificate.

(III) When the certificate verification unit 131 has successfully verified the digital signature attached to the attribute certificate, the certificate verification unit 131 verifies the information about the valid period in the attribute certificate, so as to find out when the valid period of the attribute certificate ends. Further, the certificate verification unit 131 obtains time information about the current time from the clock unit 125. The certificate verification unit 131 compares the obtained time information and the valid period information written in the attribute certificate, so as to determine whether the current time is within the valid period or not. When the current time is determined to be within the valid period, the certificate verification unit 131 outputs to the application control unit 101 the result information indicating that the attribute certificate has been successfully verified. When the current time is determined to be out of the valid period(the certificate verification unit 131 outputs to the application control unit 101 the result information indicating that the verification of the attribute certificate has failed.

When the application control unit 101 requests the authentication processing unit 109 to verify the attribute certificate, the authentication processing unit 109 does not execute authentication processing using actual biometrics information. Accordingly, as shown in FIG. 4, even when the authentication processing unit 109 has successfully verified the attribute certificate, the authentication processing unit 109 does not issue a new attribute certificate, and outputs to the application control unit 101 only the information about the verification result of the attribute certificate.

### [Regarding Hardware Configuration of Authentication Processing Unit]

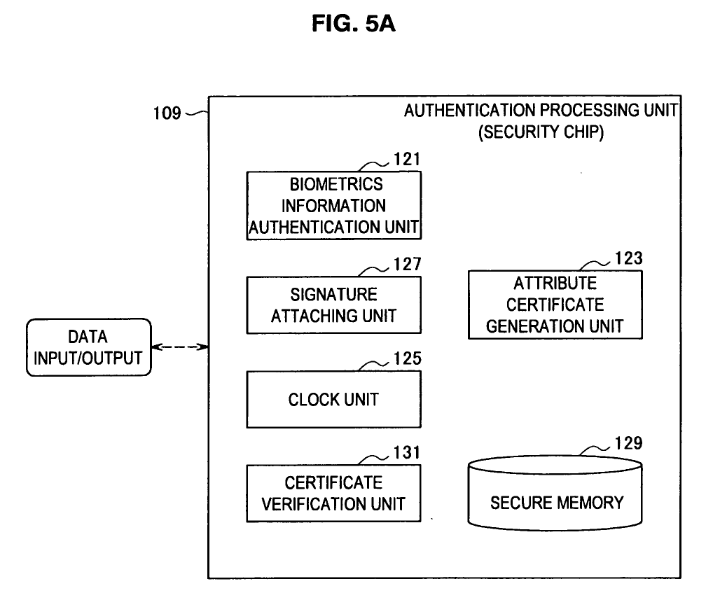

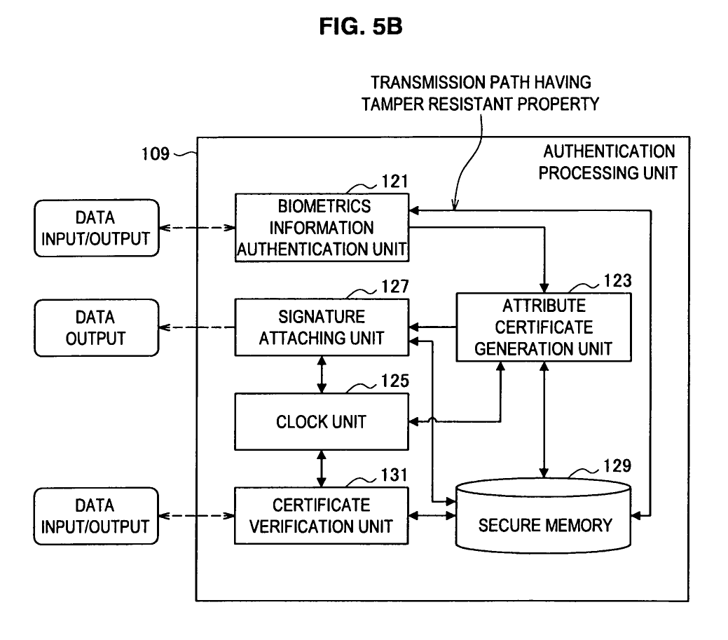

Subsequently, an overview of the hardware configuration of the authentication processing unit 109 according to the present embodiment will be described with reference to FIG. 5A and FIG. 5B. FIG. 5A and FIG. 5B are explanatory diagrams illustrating the overview of the hardware configuration of the authentication processing unit according to the present embodiment.

Each processing unit of the authentication processing unit 109 according to the present embodiment is achieved with hardware such as a CPU, a ROM, a RAM, a non-volatile memory, and the like. Various kinds of data exchanged in the authentication processing unit 109 and various kinds of logics executed by the authentication processing unit 109 need to be hidden from the outside. Accordingly, the authentication processing unit 109 itself needs to be a processing unit having a tamper resistant property.

Therefore, for example, as shown in FIG. 5A, the authentication processing unit 109 according to the present embodiment may be achieved with a single security chip, and each processing unit of the authentication processing unit 109 may share hardware such as a CPU, a ROM, a RAM, and a non-volatile memory, and the like constituting a security chip.

Since the authentication processing unit 109 is achieved with a single security chip as shown in FIG. 5A, transmission of various kinds of data between the processing units of the authentication processing unit 109 is performed within the single chip. As a result, various kinds of data exchanged in the authentication processing unit 109 and various kinds of logics executed by the authentication processing unit 109 can be hidden in the security chip except for those output to the outside of the security chip. As a result, the authentication processing unit 109 can have tamper resistant property.

Alternatively, for example, as shown in FIG. 5B, the authentication processing unit 109 according to the present embodiment may be achieved such that each processing unit of the authentication processing unit 109 according to the present embodiment may be achieved with a single security chip, and the plurality of security chips may operate in cooperation. In this case, each security chip corresponding to respective processing unit needs to be coupled with each other via a transmission path having tamper resistant property. As a result, various kinds of data exchanged in the authentication processing unit 109 and various kinds of logics executed by the authentication processing unit 109 can be hidden in the security chip except for those output to the outside of the security chip.

An example of the functions of the information processing apparatus 10 according to the present embodiment has been hereinabove described. Each of the above constituent elements may be structured using a general-purpose member and a circuit, or may be structured by hardware dedicated to the function of the respective constituent element. Alternatively, the function of each constituent element may be carried out by a CPU and the like. Therefore, the used configuration may be changed as necessary in accordance with the state of art at the time of carrying out the present embodiment.

It is possible to make a computer program for realizing the functions of the above-described information processing apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Modification of Information Processing Apparatus>

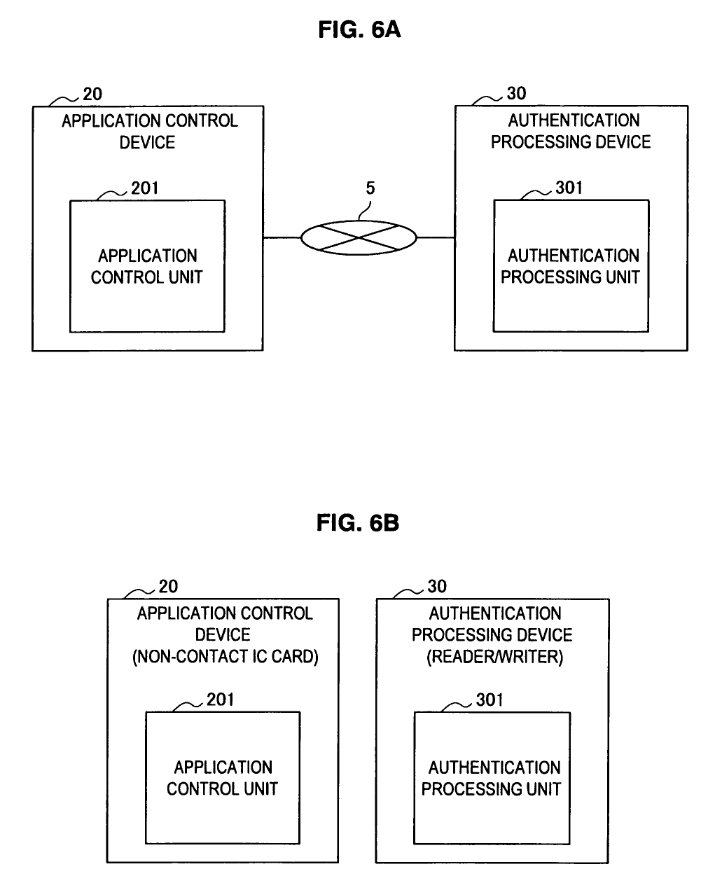

Subsequently, the modification of the information processing apparatus according to the present embodiment will be described in detail with reference to FIG. 6A and FIG. 6B. FIG. 6A and FIG. 6B are explanatory diagrams illustrating a modification of the information processing apparatus according to the present embodiment.

FIG. 1 illustrates the case where the application control unit 101 and the authentication processing unit 109 according to the present embodiment are arranged within the same apparatus (information processing apparatus 10). However, the arrangement is not limited to the above example. The application control unit 101 and the authentication processing unit 109 may be separately arranged in respective apparatuses.

For example, as shown in FIG. 6A, the application control device 20 mainly including an application control unit 201 and the authentication processing device 30 mainly including an authentication processing unit 301 may be connected with each other via a communication network 5. In this configuration, the application control device 20 includes the application control unit 201 having the same configuration and achieving the same effect as the application control unit 101 according to the present embodiment. The authentication processing device 30 includes the authentication processing unit 301 having the same configuration and achieving the same effect as the authentication processing unit 109 according to the present embodiment. In addition, the application control device 20 may be arranged with processing units having the same configurations and achieving the same effects as the imaging control unit 103, the imaging unit 105, and the biometrics information extraction unit 107 according to the present embodiment.

Herein, the communication network 5 is a communication circuit network connecting between the application control device 10 and the authentication processing device 20 so as to enable bidirectional communication or one way communication. This communication network 5 may be constituted by a public circuit network or a dedicated circuit network. Further, this communication network 5 may be connected either wirelessly or via wire. Examples of public circuit networks include the Internet, an NGN (Next Generation Network), a telephone circuit network, a satellite communication network, a simultaneous communication path, and the like. Examples of dedicated circuit networks include WAN, LAN, IP-VPN, Ethernet (registered trademark), wireless LAN, and the like.

In the example shown in FIG. 6A, the application control unit 201 of the application control device 20 requests the authentication processing device 30 connected via the communication network 5 to authenticate biometrics information, and transmits the biometrics information extracted by the application control device 20 to the authentication processing device 30. The authentication processing device 30 authenticates the transmitted biometrics information. When the authentication has succeeded, an attribute certificate is generated in the same manner as described above. The authentication processing unit 301 of the authentication processing device 30 outputs the authentication result information and the generated attribute certificate to the application control device 20 via the communication network 5. The application control device 20 storing the attribute certificate requests, via the communication network 5, the authentication processing device to verify the attribute certificate. The authentication processing device 30 notifies the verification result of the attribute certificate to the application control device 20 via the communication network 5.

The example shown in FIG. 6A shows the case where the application control device 20 and the authentication processing device 30 are connected via the communication network 5. The application control device 20 may be directly connected to the authentication processing device 30 via a predetermined interface.

In the above-described manner, the application control unit 201 and authentication processing unit 301 are implemented. Accordingly, for example, the above-described method can be applied to an electronic money use management system including, for example, a terminal capable of settling electronic money with biometrics authentication and a biometrics authentication server performing a biometrics authentication.

Alternatively, for example, as shown in FIG. 6B, the above-described application control unit 201 may be arranged within a non-contact IC card, and the above-described authentication processing unit 301 may be arranged within a reader/writer of the non-contact IC card. In the above-described manner, the application control unit 201 and the authentication processing unit 301 are implemented. Accordingly, for example, the above-described method can be applied to an automatic ticket gate system using biometrics authentication.

It should be noted that the information processing apparatus and the information processing method according to the present embodiment are not limited to the examples shown in FIG. 1, FIG. 6A, and FIG. 6B, and can be applied to apparatuses in various other forms.

### <Regarding Information Processing Method>

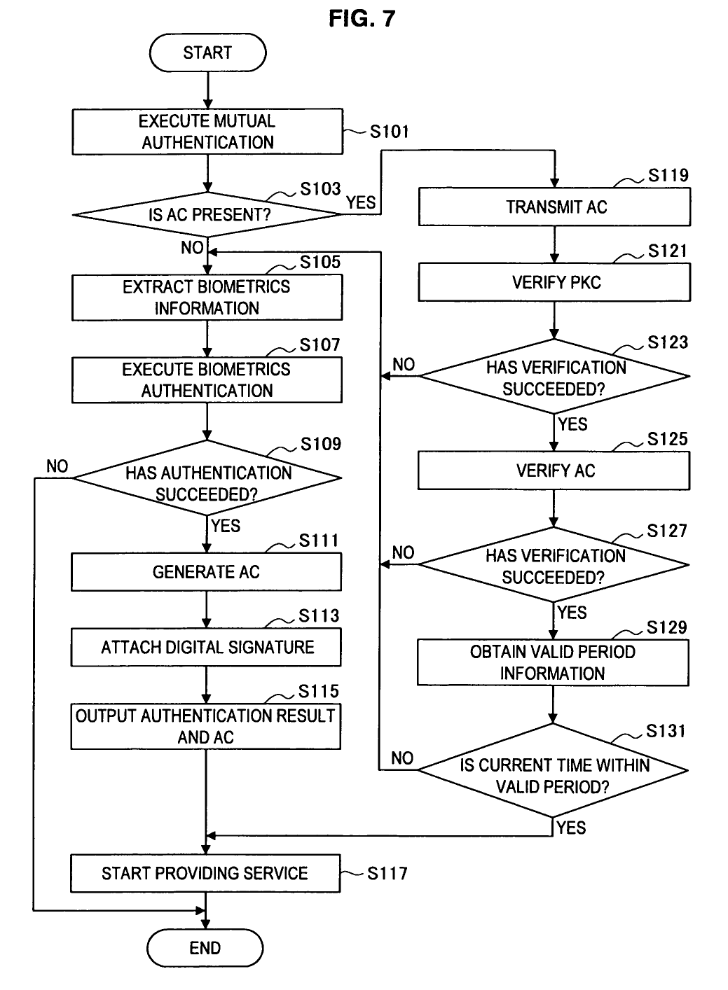

Subsequently, the information processing method carried out by the information processing apparatus according to the present embodiment will be described in detail with reference to FIG. 7. FIG. 7 is a flow diagram illustrating the information processing method according to the present embodiment.

The following example shows a case where the application control unit 101 according to the present embodiment has a public key certificate unique to the application control unit 101.

First, the application control unit 101 uses the public key certificate unique to the application control unit 101 to perform mutual authentication with the authentication processing unit 109 (step S101), and a secure transmission path is established between the application control unit 101 and the authentication processing unit 109.

Subsequently, the application control unit 101 determines whether the attribute certificate (AC) output from the authentication processing unit 109 is stored or not (step S103). When the attribute certificate is not stored, the authentication processing using biometrics information in step S105 and subsequent steps is executed. When the attribute certificate is stored, the verification processing of the attribute certificate in step S119 and subsequent steps is executed.

First, a case where the application control unit 101 does not store the attribute certificate will be described.

When the attribute certificate is not stored, the application control unit 101 requests the imaging control unit 103 to image a surface of a body, and accordingly the imaging control unit 103 controls the imaging unit 105 to image the surface of the body. The data obtained by imaging the surface of the body is transmitted to the biometrics information extraction unit 107. The biometrics information extraction unit 107 extracts biometrics information from the transmitted, imaged data (step 105). The extracted biometrics information is transmitted to the biometrics information authentication unit 121 arranged in the authentication processing unit 109. Further, the application control unit 101 requests the authentication processing unit 109 to authenticate the biometrics information, and transmits valid period information to the authentication processing unit 109. The biometrics information authentication unit 121 uses templates registered in advance to authenticate the transmitted biometrics information (step S107), and determines whether the authentication has succeeded or not (step S109).

When the authentication has failed, the biometrics information authentication unit 121 notifies the application control unit 101 of the authentication result information indicating the failure of the authentication. Accordingly, the application control unit 101 does not provide a predetermined service and stops the processing.

On the other hand, when the authentication has succeeded, the biometrics information authentication unit 121 requests the attribute certificate generation unit 123 to generate an attribute certificate. The attribute certificate generation unit 123 generates an attribute certificate (AC) by using the valid period information notified by the application control unit 101 and the time information obtained from the clock unit 125 (step S111). Thereafter, the attribute certificate generation unit 123 transmits the generated attribute certificate to the signature attaching unit 127.

The signature attaching unit 127 having obtained the attribute certificate uses a secret key unique to the authentication processing unit 109 to attach a digital signature to the obtained attribute certificate (step S113). Thereafter, the authentication processing unit 109 outputs to the application control unit 101 both of the obtained authentication result information (indicating the success of the authentication) and the attribute certificate attached with the digital signature (step S115).

When the application control unit 101 obtains the attribute certificate, the application control unit 101 stores the obtained attribute certificate to a predetermined position, and starts providing a predetermined service based on the authentication result information indicating the success of the authentication (step S117).

Subsequently, a case where the application control unit 101 has the attribute certificate will be described.

When the application control unit 101 has the attribute certificate, the application control unit 101 transmits the stored attribute certificate to the authentication processing unit 109 (step S119).

The certificate verification unit 131 of the authentication processing unit 109 authenticates the public key certificate associated with the transmitted attribute certificate (step S121). More specifically, the certificate verification unit 131 obtains the public key corresponding to the public key certificate, verifies the digital signature attached to the public key certificate, and determines whether the verification has succeeded or not (step S123).

When the verification of the public key certificate has failed, the certificate verification unit 131 notifies the application control unit 101 that the verification of the public key certificate has failed. When the application control unit 101 receives the notification, the application control unit 101 requests the authentication processing unit 109 to perform authentication using biometrics information in step S105 and subsequent steps.

Alternatively, when the public key certificate has been successfully verified, the certificate verification unit 131 verifies the integrity of the transmitted attribute certificate (step S125). More specifically, the certificate verification unit 131 uses the public key unique to the authentication processing unit 109 to verify the digital signature attached to the attribute certificate, and determines whether the verification has succeeded or not (step S127).

When the verification of the attribute certificate has failed, the certificate verification unit 131 notifies the application control unit 101 that the verification of the attribute certificate has failed. When the application control unit 101 receives the notification, the application control unit 101 requests the authentication processing unit 109 to perform authentication using biometrics information in step S105 and subsequent steps.

When the verification of the attribute certificate has succeeded, the certificate verification unit 131 references the attribute certificate, and obtains the valid period information about the valid period of this attribute certificate (step S129). Subsequently, the certificate verification unit 131 obtains the time information about the current time from the clock unit 125, and determines whether the current time is within the valid period of the attribute certificate (step S131).

When the current time is not within the valid period, the certificate verification unit 131 notifies the application control unit 101 that the current time is out of the valid period of the attribute certificate. When the application control unit 101 receives the notification, the application control unit 101 requests the authentication processing unit 109 to perform authentication using biometrics information in step S105 and subsequent steps.

When the current time is within the valid period, the certificate verification unit 131 notifies the application control unit 101 that the verification of the attribute certificate has succeeded. When the application control unit 101 receives the notification, the application control unit 101 deems that the verification of the biometrics information has succeeded, and starts providing a predetermined service (step S117).

As described above, in the information processing method according to the present embodiment, an attribute certificate is generated when the authentication has succeeded. When it is necessary to proceed to authentication of biometrics information, and the verification of the attribute certificate has succeeded, the latest result of the biometrics authentication is reused, and it is deemed that the authentication of the biometrics information has succeeded. Therefore, the safety of biometrics authentication can be maintained, and it is possible to prevent the deterioration of the operability of the apparatus caused by taking biometrics information many times.

### (Regarding Hardware Configuration)

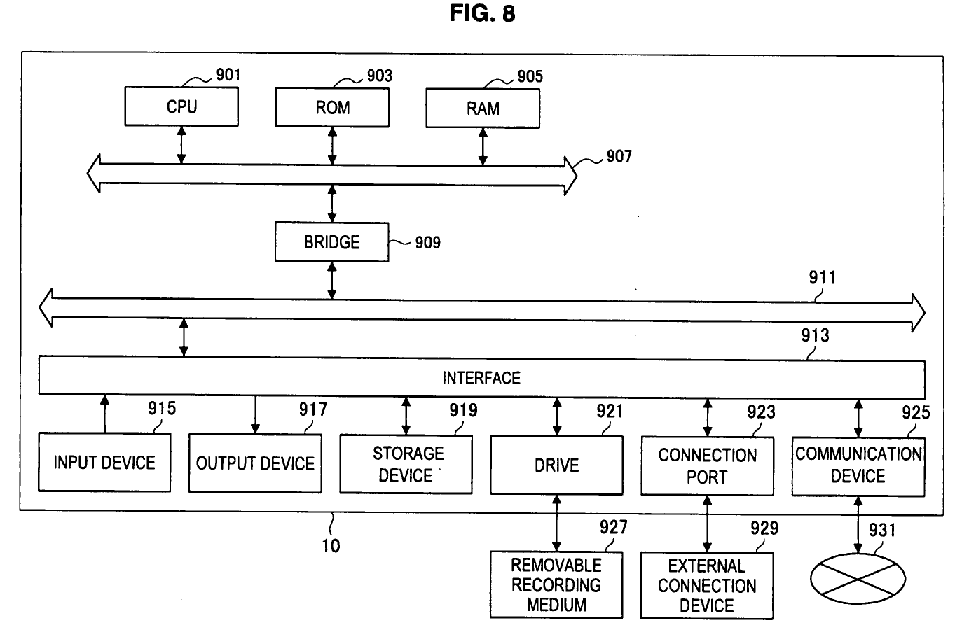

Subsequently, a hardware configuration of the information processing apparatus 10 according to the embodiment of the present invention will be described in detail with reference to FIG. 8. FIG. 8 is a block diagram illustrating a hardware configuration of the information processing apparatus 10 according to the embodiment of the present invention.

The information processing apparatus 10 mainly includes not only the above-described imaging unit 105 and the security chip, but also a CPU 901, a ROM 903, and a RAM 905. Further, the information processing apparatus 10 includes a host bus 907, a bridge 909, an external bus 911, an interface 913, an input device 915, an output device 917, a storage device 919, a drive 921, a connection port 923, and a communication device 925.

The CPU 901 functions as a processing unit and a control unit, and it controls the whole or a part of operation in the information processing apparatus 10 according to various kinds of programs stored in the ROM 903, the RAM 905, the storage device 919 or a removable recording medium 927. The ROM 903 stores a program to be used by the CPU 901, a processing parameter and the like. The ROM 903 stores a program to be used by the CPU 901, a processing parameter and so on. The RAM 905 primarily stores programs used by the CPU 901 in the execution, parameters and the like that are changed during the execution. The CPU 901, the ROM 903 and the RAM 905 are connected with one another through the host bus 907, which is an internal bus such as a CPU bus.

The host bus 907 is connected to the external bus 911 such as a Peripheral Component Interconnect/Interface (PCI) bus via the bridge 909.

The input device 915 is an operating means to be operated by a user, such as a mouse, a keyboard, a touch panel, buttons, a switch or a lever, for example. For example, the input device 915 may be a remote controlling means (or a remote control) with an infrared ray or another radio wave, or an externally connected device 929 compatible with the operation of the information processing apparatus 10, such as a cellular phone or a PDA. Further, the input device 915 includes an input control circuit that generates an input signal based on information input by a user using the above operating means and outputs it to the CPU 901, for example. By operating this input device 915, a user of the information processing apparatus 10 can input various kinds of data or give an instruction of a processing operation to the information processing apparatus 10.

The output device 917 includes an apparatus capable of visually or audibly notifying obtained information to the user. Examples of such apparatus include a display device such as a CRT display device, a liquid crystal display device, a plasma display device, an EL display device or a lamp, an audio output device such as a speaker or a headphone, or a printer, a cellular phone or a facsimile. The output device 917 outputs, for example, results obtained by various processing by the information processing apparatus 10. Specifically, the display device displays, as a text or an image, a result obtained by various processing of the information processing apparatus 10. The audio output device converts an audio signal containing reproduced audio data, acoustic data or the like into an analog signal and outputs it.

The storage device 919 is a device for data storage that is configured as an example of a storage unit of the information processing apparatus 10. The storage device 919 may include a magnetic storage device such as a hard disk drive (HDD), a semiconductor storage device, an optical storage device, a magneto-optical storage device or the like. This storage device 919 stores a program to be executed by the CPU 901, various data, or various data acquired from the outside, for example.

The drive 921 is a reader/writer for a recording medium, which is built in the information processing apparatus 10 or attached thereto. The drive 921 reads information that is recorded in the removable recording medium 927 such as a magnetic disk, an optical disk, a magneto-optical disk or semiconductor memory which is attached thereto and outputs the information to the RAM 905. Further, the drive 921 can write information into the removable recording medium 927 such as a magnetic disk, an optical disk, a magneto-optical disk or semiconductor memory which is attached thereto. Examples of the removable recording medium 927 include a DVD medium, an HD-DVD medium, and a Blu-ray medium. In addition, examples of the removable recording medium 927 include a compact flash (registered trademark) (CF), a memory stick, and a secure digital (SD) memory card. Further, the removable recording medium 927 may be an integrated circuit (IC) card equipped with a contactless IC chip or an electronic appliance.

The connection port 923 is a port for directly connecting devices to the information processing apparatus 10. Examples of the connection port 923 include a universal serial bus (USB) port, an IEEE 1394 port such as i.Link, and a small computer system interface (SCSI) port. In addition, examples of the connection port 923 include an RS-232C port, an optical audio terminal, and a high-definition multimedia interface (HDMI) port. By connecting the externally connected device 929 to the connection port 923, the information processing apparatus 10 can directly acquire various data from the externally connected device 929 or supply various data to the externally connected device 929.

The communication device 925 is a communication interface that is constituted by a communication device or the like for connecting to a communication network 931, for example. The communication device 925 may be a communication card for wired or wireless local area network (LAN), Bluetooth (registered trademark), or wireless USB (WUSB). Alternatively, the communication device 925 may be a router for optical communication, a router for asymmetric digital subscriber line (ADSL), or a modem for each kind of communication. This communication device 925 can transmit and receive a signal or the like in conformity to a prescribed protocol such as TCP/IP on the Internet or with other communication devices, for example. Further, the communication network 931 that is connected to the communication device 925 includes a wired or wireless network or the like, and it may be the Internet, home LAN, infrared data communication, radio wave communication, satellite communication or the like.

An example of the hardware configuration that can implement the functions of the information processing apparatus 10 according to each embodiment of the present invention has been described in the foregoing. Each of the above-described elements may be constituted using a general-purpose member or circuit, or it may be constituted by hardware specialized to the function of each element. It is thereby possible to change the configuration to be used as appropriate according to the technique level when implementing the embodiment.

### (Summary)

As described above, the information processing apparatus and the information processing method according the embodiment of the present invention can be applied to achieve Single Sign-On with biometrics authentication, and can be applied to scenes in which biometrics authentication is used, such as a ticket gate at a station, a cash desk of a convenience store, and a vending machine. As long as a biometrics authentication system is established using a portable terminal, a non-contact IC card, and the like, and biometrics authentication is completed before the time of actual use, it is not necessary to take biometrics information at the time of actual use, the security of biometrics authentication can be maintained by holding the portable terminal and the like over the apparatus. Further, permissions of reuse contained in the attribute certificate can be changed by a party outside of the authentication processing unit according to the service using biometrics authentication. Therefore, the information processing apparatus and the information processing method according the embodiment of the present invention is not limited to a simple validity period management, and can be flexibly applied to various systems.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-165403 filed in the Japan Patent Office on Jul. 14, 2009, the entire content of which is hereby incorporated by reference.

What is claimed is:

1. An information processing apparatus comprising:
an authentication processing unit that authenticates biometrics information unique to a living body; and
an application control unit that controls an application providing a predetermined service according to the authentication result of the biometrics information, and that requests the authentication processing unit to authenticate the biometrics information,
wherein the authentication processing unit includes:
a biometrics information authentication unit that authenticates the biometrics information based on registered biometrics information that is biometrics information registered in advance; and
an attribute certificate generation unit that generates an attribute certificate indicating information about a valid period of the authentication result of the biometrics information, when the biometrics information authentication unit successfully authenticates the biometrics information, and
when the attribute certificate is issued for the biometrics information whose authentication is requested, the application control unit stores the issued attribute certificate.

2. The information processing apparatus according to claim 1,
wherein when the application control unit has the attribute certificate, the application control unit requests the authentication processing unit to verify the attribute certificate instead of authenticating the biometrics information,
the authentication processing unit further includes a certificate verification unit that verifies the attribute certificate transmitted from the application control unit and outputs the verification result of the attribute certificate to the application control unit, and
when a time at which the verification is performed is determined to be within the valid period indicated in the attribute certificate, the certificate verification unit determines that the attribute certificate has been successfully verified.

3. The information processing apparatus according to claim 2,
wherein the application control unit notifies the authentication processing unit of information about the valid period of the authentication result when the biometrics information is successfully authenticated, and
the attribute certificate generation unit determines the valid period of the attribute certificate based on the information about the valid period notified by the application control unit.

4. The information processing apparatus according to claim 2,
wherein when the time at which the verification is performed is determined not to be within the valid period, the certificate verification unit notifies the application control unit that the attribute certificate is out of the valid period, and
when the application control unit obtains the notification, the application control unit requests the authentication processing unit to authenticate the biometrics information.

5. The information processing apparatus according to claim 2,
wherein the authentication processing unit further includes:
a storage unit that stores a key pair unique to the authentication processing unit, the key pair including a public key and a secret key; and
a signature attaching unit that uses the key pair to attach a digital signature to the attribute certificate generated by the attribute certificate generation unit, and
the certificate verification unit uses the key pair to verify the digital signature attached to the attribute certificate before verifying the valid period.

6. An information processing method, wherein an information processing apparatus includes an authentication processing unit and an application control unit, wherein the authentication processing unit includes a biometrics information authentication unit and an attribute certificate generation unit, wherein the biometrics information authentication unit authenticates biometrics information unique to a living body based on registered biometrics information that is biometrics information registered in advance, wherein the attribute certificate generation unit generates an attribute certificate indicating information about a valid period of the authentication result of the biometrics information when the biometrics information authentication unit successfully authenticates the biometrics information, wherein the application control unit controls an application providing a predetermined service according to the authentication result of the biometrics information and requests the authentication processing unit to authenticate the biometrics information, and
wherein the information processing method comprising the steps of:
causing the application control unit to request the biometrics information authentication unit to authenticate the biometrics information;
causing the biometrics information authentication unit to authenticate the biometrics information;
causing the attribute certificate generation unit to generate an attribute certificate indicating information about the valid period of the authentication result of the biometrics information, when the biometrics information has been successfully authenticated; and
causing the application control unit to store the attribute certificate generated for the biometrics information whose authentication is requested.

7. A program for causing a computer to achieve:
a biometrics information authentication function for authenticating biometrics information unique to a living body based on registered biometrics information that is biometrics information registered in advance;
an attribute certificate generation function for generating an attribute certificate indicating information about a valid period of an authentication result of the biometrics information when the biometrics information has been successfully authenticated; and
an application control function for controlling an application providing a predetermined service according to the authentication result of the biometrics information and requesting the biometrics information authentication function to authenticate the biometrics information, wherein the application control function stores the attribute certificate when the attribute certificate is generated for the biometrics information whose authentication is requested.
